(19) United States
(12) Patent Application Publication
(10) Pub. No.: US 2004/0223275 A1
(43) Pub. Date: Nov. 11, 2004

(54) Relay unit of power line communication device for vehicle

(76) Inventors: Yo Yanagida, Shizuoka-ken (JP); Terumitsu Sugimoto, Shizuoka-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/652,201

(22) Filed: Sep. 2, 2003

(30) Foreign Application Priority Data
Sep. 3, 2002 (JP) P 2002-257581

(51) Int. Cl. H02H 3/00

(52) U.S. Cl. 361/62

(57) ABSTRACT

In a relay unit, a communication signal is blocked and separated by a separator inserted to a power line. The communication signal provided from one end or another end of the separated power line through a switch is received by a receiver. The received communication signal is relayed by a processor, and the relayed communication signal is transmitted from a transmitter to the one end or the other end of the power line.

### BACKGROUND OF THE INVENTION

1. Field of the Invention

This invention relates to a relay unit for relaying communication signals between power line communication devices configured to superimpose various signals used in a vehicle on a power line so as to perform communication.

2. Description of the Related Art

Performance of automobiles continues to advance in recent years and a plurality of electronic control units (ECUs) are loaded on a vehicle. The ECUs are provided not only to control an engine and a transmission, but also to control power windows, lamps, side mirrors, and the like. The respective ECUs operate in relation to one another. Accordingly, the respective ECUs are mutually connected through exclusive signal lines provided between the ECUs or through a common bus to the ECUs, and signals are inputted and outputted through the signal lines or through communication lines in the bus.

Recently, the number of communication lines connecting among the ECUs tends to be increased due to an increase in the number of ECUs to be loaded on a vehicle or an increase in the number of signals associated with more intricate control. Such an increase in the communication lines raises a problem of an increase in size and cost of a wire harness including the communication lines.

To solve this problem, a technique has been developed in which communication between ECUs is performed by means of interposing signals inputted to and outputted from the ECUs on a power line configured to supply electricity to the ECUs (Japanese Patent Application No. 2002-257581). This technique reduces the number of communication lines, thereby solving the above-mentioned problem.

### SUMMARY OF THE INVENTION

FIG. 1 is a view schematically showing a proposed configuration of an ECU 100. In FIG. 1, a power supply voltage for a vehicle to be supplied though a power line 102 having a bypass capacitor 101 connected thereto for suppressing voltage fluctuation, such as a 12 V power supply voltage, is converted into an operating power source voltage for electronic devices inside the vehicle at 5 V, for example, by a power source circuit 103 including a regulator and is then supplied to the electronic devices inside the vehicle. A load controller 104 composed of switching elements such as relays is switch-controlled based on a load control signal so as to control a load drive current which is provided through the power line 102. A load 105 such as a drive motor for a power window or a side mirror, or a lamp, is driven by the drive current provided from the power line 102 through the load controller 104. A power line communication device for vehicle (hereinafter referred to as a “PLC”) 106 is connected to the power line 102 for superimposing signals on the power line 102 to perform communication between the ECUs.

In the PLC 106, when the ECU 100 receives the communication signal, a communication signal modulated and superimposed on the power line 102 is provided to a comparator 108 through a bandpass filter 107. The communication signal is compared with a standard level for comparison by the comparator 108 and is then amplified. The amplified communication signal is detected by a detector 109 to obtain incoming data. The obtained incoming data are provided to a processor 110 for executing various processes, and the load control signal is generated in one of the processes and is provided to the load controller 104.

Meanwhile, when the ECU transmits the communication signal, outgoing data generated by the processor 110 are provided to a modulator 111. Further, the outgoing data provided to the modulator 111 are modulated together with a carrier wave oscillated by a carrier wave oscillator 112. The modulated outgoing data are provided to the power line 102 through an output part 113 and are superimposed on direct-current power of the power line 102, and then transmitted.

The ECU 100 including the PLC 106 is disposed in a predetermined position inside the vehicle. Here, a communication distance between the ECUs 100 using the PLC 106 has been limited to a range of 3 to 5 m, for example. This is because the communication signal superimposed on the power line 102 is attenuated by a capacitor, which is connected to the power line 102 to reduce noises, for example, of an electronic device for receiving power supply from the power line 102. Accordingly, long-distance communication has not been possible inside the vehicle applying the PLC 106.

As a consequence, three slave side ECUs disposed in the vicinity of loads corresponding to respective drive motors for driving the loads including a power window, a side mirror and a door lock, for example, and a master side ECU for communicating with these three slave ECUs are provided for each door. Here, the ECUs provided for the respective doors are independent of one another. That is, communication takes place within the ECUs provided for each door, and communication between the ECUs provided for different doors was not possible because of a long communication distance.

An increase in an output voltage of the communication signal is conceivable to realize such long-distance communication. However, the increase in the output voltage of the communication signal causes such a failure that power consumption is increased. Moreover, the increase in the out put voltage of the communication signal also causes such a failure that radiated noises to be radiated from the power line superimposing the communication signal thereon are increased and the noises adversely affect the electronic devices.

Meanwhile, an increase in receiver sensitivity for the communication signal is also conceivable to realize the long-distance communication. However, the increase in the receiver sensitivity for the communication signal causes deterioration of noise resistance to exogenous noises provided to the power line, and the communication signal may pick up the noises more often. Accordingly, there arises a problem that a communication error rate of an incoming signal is increased and communication quality is thereby decreased.

In view of the above-described problems, an object of this invention is to provide a relay unit of a power line communication device for vehicle which enables long-distance communication without causing an increase in power consumption or deterioration of communication quality.

To attain the object, a first aspect of the present invention is a relay unit of a power line communication device for vehicle, which is inserted to a power line connecting between power line communication devices for vehicle configured to superimpose a communication signal on direct-current power of the power line provided to supply the direct-current power to a vehicle, and then transmitted. Moreover, the relay unit is configured to relay the communication signal between the power line communication devices for vehicle. Here, the relay unit of a power line communication device for vehicle includes: a separator which is inserted to the power line provided to supply power to the power line communication devices for vehicle and is configured to block and separate the communication signal transmitted on the power line; a first switch connected to one end of the power line separated by the separator; a second switch connected to another end of the power line separated by the separator; a first receiver configured to receive the communication signal provided from the power line through the first switch; a second receiver configured to receive the communication signal provided from the power line through the second switch; a first transmitter configured to output and transmit the communication signal received and relayed by the first receiver to the other end of the power line through the second switch; a second transmitter configured to output and transmit the communication signal received and relayed by the second receiver to the one end of the power line through the first switch; and a processor configured to receive the communication signal received by the first receiver and relay the communication signal so as to provide the relayed communication signal to the first transmitter, to receive the communication signal received by the second receiver and relay the communication signal so as to provide the relayed communication signal to the second transmitter, and to switch-control the first and second switches.

According to this aspect of the present invention, it is possible to relay the communication signal transmitted from the one end of the power line separated by the separator and to transmit the relayed communication signal to the other end of the power line separated by the separator. By disposing the relay unit appropriately on the power line, it is possible to achieve long-distance communication of the communication signal without causing an increase in power consumption, an increase in radiated noises, or an increase in a communication error rate.

Moreover, a second aspect of the present invention is a relay unit of a power line communication device for vehicle, which is inserted to a power line connecting between power line communication devices for vehicle configured to superimpose a communication signal on direct-current power of the power line provided to supply the direct-current power to a vehicle, which is then transmitted, wherein the relay unit is configured to relay the communication signal between the power line communication devices for vehicle, said relay unit of a power line communication device for vehicle including: a separator which is inserted to the power line provided to supply power to the power line communication devices for vehicle and is configured to block and separate the communication signal transmitted on the power line; a first switch connected to one end of the power line separated by the separator; a second switch connected between another end of the power line separated by the separator and the first switch; a receiver configured to receive the communication signal provided from the power line through any of the first switch and the second switch; a transmitter configured to output and transmit the communication signal received and relayed by the receiver to any of the one end and the other end of the power line through any of the first switch and the second switch; and a processor configured to receive the communication signal received by the receiver and relay the communication signal so as to provide the relayed communication signal to the transmitter, to judge a direction of transmission of the received communication signal based on a signal pattern of the communication signal, and to switch-control the first and second switches in accordance with a result of judgment.

According to this aspect of the present invention, it is possible to relay the communication signal transmitted from the one end of the power line separated by the separator and to transmit the relayed communication signal to the other end of the power line separated by the separator. By disposing the relay unit appropriately on the power line, it is possible to achieve long-distance communication of the communication signal without causing an increase in power consumption, an increase in radiated noises, or an increase in a communication error rate. In addition, it is possible to downsize the configuration of the relay unit.

Moreover, in a preferred embodiment of the present invention, the relay unit is inserted to the power line connecting between the power line communication devices for vehicle which are disposed in front and rear doors of the vehicle, and the relay unit relays a communication signal transmitted between the power line communication devices for vehicle through the power line.

According to this aspect of the present invention, the power line communication device for vehicle disposed in the front door and the power line communication device for vehicle disposed in the rear door can communicate with each other through the power line. In this way, one master side power line communication device for vehicle can control the slave side power line communication devices for vehicle disposed in the front and rear doors. Accordingly, it is not necessary to dispose plural master power line communication devices for vehicle.

Moreover, the relay unit may be inserted to the power line connecting between the power line communication devices for vehicle which are disposed in right and left doors of the vehicle, and the relay unit may relay a communication signal transmitted between the power line communication devices for vehicle through the power line.

According to this aspect of the present invention, the power line communication devices for vehicle disposed in the right and left doors can communicate with each other through the power line. In this way, it is possible to control all the power line communication devices for vehicle disposed in the front, rear, right, and left doors collectively.

### BRIEF DESCRIPTION OF THE DRAWINGS

FIG. 1 is a view showing a configuration of an electronic control unit (ECU) of a pending application which includes a power line communication device for vehicle.

FIG. 2 is a view showing a configuration of a relay unit of a power line communication devices for vehicle (PLC) according to one embodiment of this invention.

FIG. 3 is a view showing a configuration of a relay unit of a power line communication devices for vehicle (PLC) according to another embodiment of this invention.

FIG. 4 is a view showing an embodiment of arrangement positions of the relay units shown in FIG. 2 or FIG. 3 in a vehicle.

FIG. 5 is a view showing another embodiment of arrangement positions of the relay units shown in FIG. 2 or FIG. 3 in a vehicle.

### DETAILED DESCRIPTION OF THE PREFERRED EMBODIMENT

Now, an embodiment of this invention will be described with reference to the accompanying drawings.

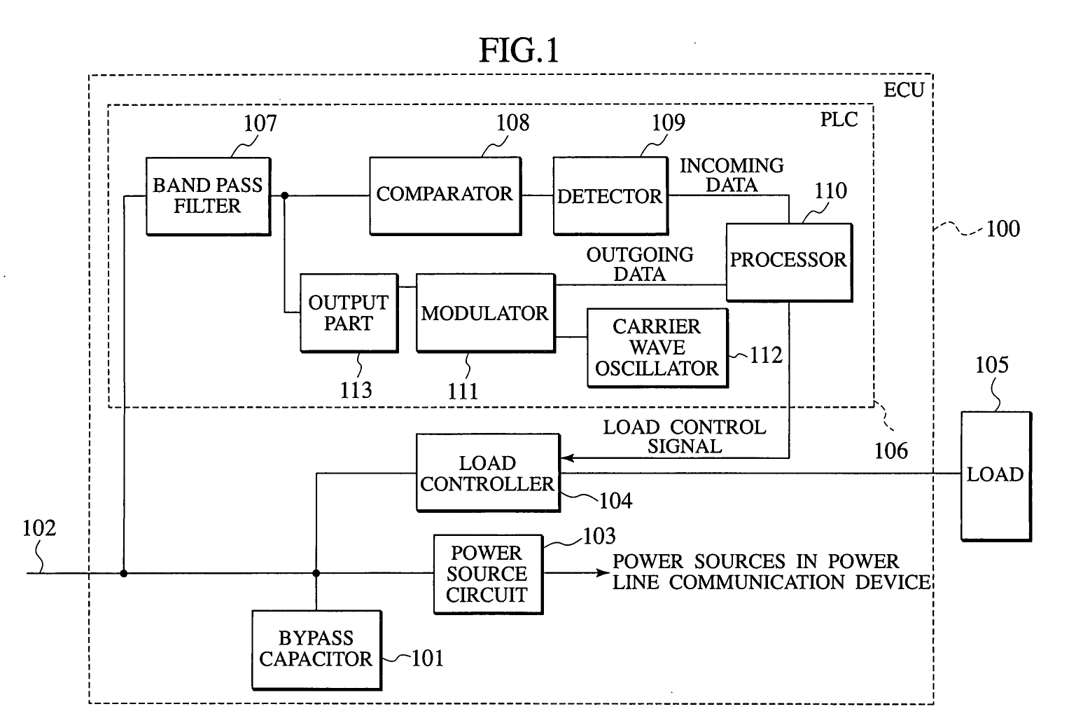

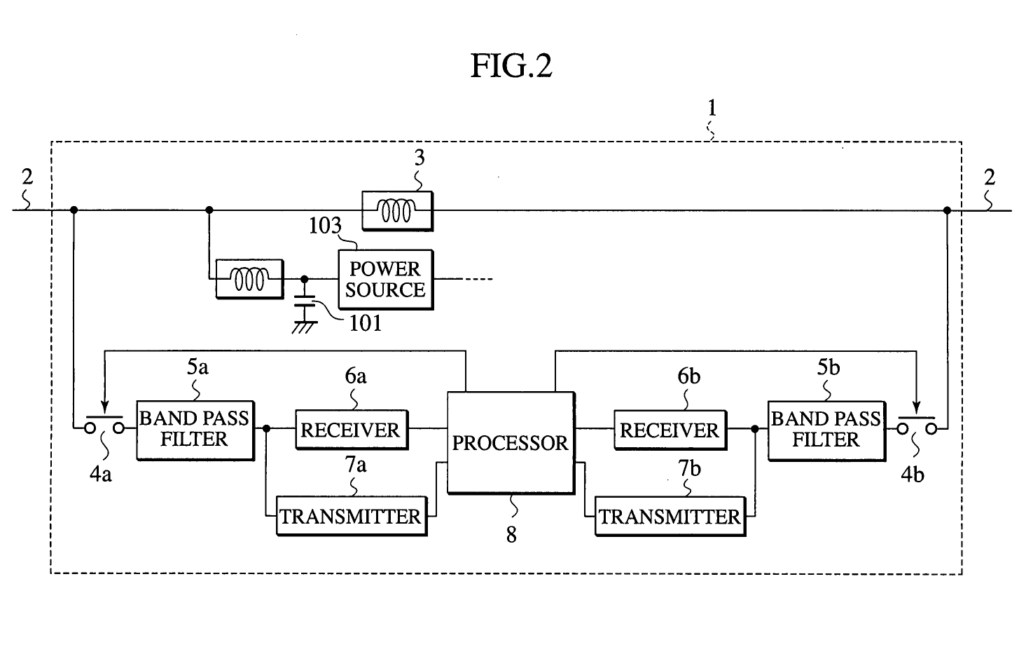

FIG. 2 is a view showing a configuration of a relay unit of a power line communication devices for vehicle (PLC) according to one embodiment of this invention. In FIG. 2, a relay unit 1 is provided on a power line 2 for supplying power to a vehicle, and is configured to relay a communication signal when communication is performed between ECUs by superimposing the communication signal on the power line 2 using the PLC, which is included in the ECU connected to the power line 2, so as to enable long-distance communication. The relay unit 1 includes an impedance element 3, switches 4a and 4b, bandpass filters 5a and 5b, receivers 6a and 6b, transmitters 7a and 7b, and a processor 8. Note that a capacitor 101 and a power source circuit 103 in FIG. 2 have functions identical to those denoted by the same numbers in FIG. 1, and description thereof will be omitted.

The impedance element 3 is made of a coil, for example, and inserted to the power line 2 so as to separate the power line 2 with respect to a communication signal superimposed on the power line 2 and thereby to block transmission of the communication signal. Specifically, the impedance element 3 separates the power line 2 with respect to the communication signal and blocks transmission thereof in order to input the superimposed communication signal to the power line 2 on one end side separated by the impedance element 3 and to relay and transmit the inputted communication to the power line 2 on another end side separated by the impedance element 3, or conversely, in order to input the superimposed communication signal to the power line 2 on the other end side separated by the impedance element 3 and to relay and transmit the inputted communication to the power line 2 on the one end side separated by the impedance element 3.

The switches 4a and 4b are severally connected between the power line 2 and the bandpass filters 5a and 5b, to thereby control input and output of the communication signal superimposed on the power line 2 between the power line and the relay unit 1. The switches 4a and 4b are both turned on at an initial state. In a state of transmitting an incoming signal, the switches 4a and 4b are controlled such that either one of the switches 4a or 4b on the side where the received communication signal is inputted is set to an off state and the other one of the switches 4a and 4b on the side where the communication signal is outputted is set to an on state.

The bandpass filters 5a and 5b input the communication signal from the power line 2 through the corresponding switches 4a and 4b, and remove low-frequency and high-frequency noise components from the inputted communication signal. The communication signal after removing the noise components is provided to the receivers 6a and 6b. Here, a digital signal communicated between the ECUs is subjected to amplitude shift keying (ASK) modulation to a higher frequency and is transmitted to the power line 2 as will be described later.

The receivers 6a and 6b amplify the communication signal by comparing the communication signal provided from and modulated by the bandpass filters 5a and 5b with a standard level for comparison. The receivers 6a and 6b detect the amplified communication signal and extract the communication signal superimposed on the power line 2 as the communication signal composed of a digital signal. The receivers 6a and 6b include the comparators 108 and the detectors 109 shown in FIG. 1, for example. The communication signal composed of the digital signal thus extracted is provided to the processor 8.

The transmitters 7a and 7b receives the communication signal composed of the digital signal provided from the processor 8, then modulates the communication signal together with a carrier wave, and output and transmit the modulated communication signal to the power line 2 through either one of the bandpass filters 5a or 5b and either one of the switches 4a or 4b. The transmitters 7a and 7b include the modulators 111, the carrier wave oscillators 112, and the output parts 113 shown in FIG. 1, for example.

The method for modulating the communication signal includes an amplitude shift keying (ASK) modulation method, for example. In the multiplex communication realized by superimposing the communication signal (a baseband) on the power line 2, if the carrier wave has a low frequency in a range from several hundred hertz to several kilohertz, for example, the communication signal is significantly attenuated by a bypass capacitor mounted on an electronic device connected to the power line 2. Therefore, attenuation of the communication signal attributable to the bypass capacitor is suppressed by subjecting the communication signal to the ASK modulation at a high frequency of several megahertz (2.5 MHz, for example), and the power source superimposing multiplex communication can be performed stably. Moreover, the ASK modulation can be realized by a simple constitution and at a low cost as compared to other modulation methods.

The processor 8 is comprised of a computer such as a central processing unit (CPU). The processor 8 receives the communication signal provided from either one of the receivers 6a or 6b, and relays the communication signal. The relayed communication signal is provided to either one of the transmitters 7a or 7b. Moreover, the processor 8 switch-controls the switches 4a and 4b as described previously, based on the receivers 6a and 6b which receive the communication signal and the transmitters 7a and 7b which transmit the communication signal. The processor 8 is designed to judge a direction of reception of the communication signal depending on a port used to input the communication signal from the receivers 6a and 6b to the processor 8, for example.

In this configuration, both of the switches 4a and 4b are turned on at an initial state. In this state, when the communication signal is transmitted from the left direction of the power line 2 in FIG. 2 and received by the receiver 6a through the switch 4a and the bandpass filter 5a, for example, the received communication signal is demodulated and detected, and is then provided to the processor 8. At this time, the switch 4a is turned off under control by the processor 8. The communication signal provided to the processor 8 is relayed by the processor 8 and then provided to the transmitter 7b. The communication signal provided to the transmitter 7b is modulated and provided to the power line 2 through the bandpass filter 5b and the switch 4b, and is superimposed on the direct-current power of the power line 2 and transmitted to the right direction of FIG. 2.

On the contrary, when the communication signal is transmitted from the right direction of the power line 2 in FIG. 2 and received by the receiver 6b through the switch 4b and the bandpass filter 5b, for example, the received communication signal is demodulated and detected, and is then provided to the processor 8. At this time, the switch 4b is turned off under control by the processor 8. The communication signal provided to the processor 8 is relayed by the processor 8 and then provided to the transmitter 7a. The communication signal provided to the transmitter 7a is modulated and provided to the power line 2 through the bandpass filter 5a and the switch 4a, and is superimposed on the direct-current power of the power line 2 and transmitted in the left direction of FIG. 2.

By performing relays as described above, it is possible to relay the communication signal transmitted from one end of the power line 2 separated by the impedance element 3, and to transmit the relayed communication signal to another end of the power line 2 separated by the impedance element 3. By disposing the relay unit 1 appropriately on the power line 2, it is possible to achieve long-distance communication of the communication signal without causing an increase in power consumption, an increase in radiated noises, or an increase in a communication error rate.

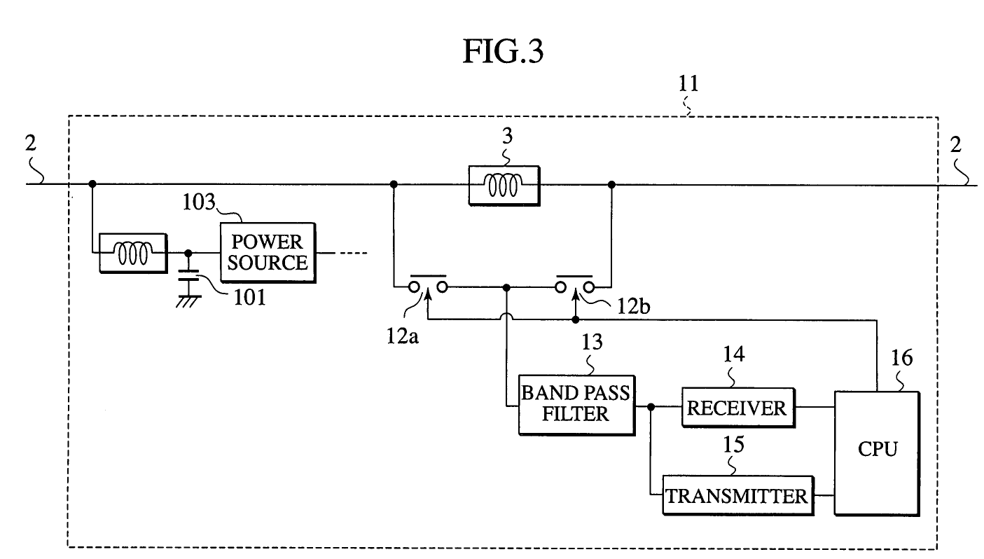

FIG. 3 is a view showing a configuration of a relay unit of a power line communication devices for vehicle (PLC) according to another embodiment of this invention. This embodiment is characterized in that pairs of the bandpass filters 5a and 5b, the receivers 6a and 6b, and the transmitters 7a and 7b shown in FIG. 2 are severally reduced to single pieces.

As shown in FIG. 3, switches 12a and 12b are connected in series in a relay unit 11, and the switches 12a and 12b connected in series are connected in parallel with an impedance element 3 which separates a power line 2. A bandpass filter 13, which functions similarly to the bandpass filters 5a and 5b shown in FIG. 2, is connected to a serial connection point of the switches 12a and 12b. A receiver 14 which functions similarly to the receivers 6a and 6b shown in FIG. 2, and a transmitter 15 which functions similarly to the transmitters 7a and 7b shown in FIG. 2 are connected to the bandpass filter 13. A processor 16 is connected to the receiver 14 and the transmitter 15.

In addition to the functions of the processor 8 shown in FIG. 2, the processor 16 is designed to specify a direction of transmission of a communication signal on the power line 2 based on a communication pattern of the communication signal.

The processor 16 switch-controls the switches 12a and 12b during transmission of the communication signal based on the specified direction of transmission of the communication signal.

In this configuration, both of the switches 12a and 12b are turned on at an initial state. In this state, when the communication signal is transmitted from the left direction of the power line 2 in FIG. 3 and received by the receiver 14 through the switch 12a and the bandpass filter 13, for example, the received communication signal is demodulated and detected, and is then provided to the processor 16. The processor 16 judges the direction of transmission based on the signal pattern of the received communication signal. When the direction of transmission of the communication signal is judged, the switch 12a is turned off under control by the processor 16. The communication signal provided to the processor 16 is relayed by the processor 16 and then provided to the transmitter 15. The communication signal provided to the transmitter 15 is modulated and provided to the power line 2 through the bandpass filter 13 and the switch 12b, and is superimposed on direct-current power of the power line 2 and transmitted in the right direction of FIG. 3.

Meanwhile, when the communication signal is transmitted from the right direction of the power line 2 in FIG. 3 and received by the receiver 14 through the switch 12b and the bandpass filter 13, for example, the received communication signal is demodulated and detected, and is then provided to the processor 16. The processor 16 judges the direction of transmission based on the signal pattern of the received communication signal. When the direction of transmission of the communication signal is judged, the switch 12b is turned off under control by the processor 16. The communication signal provided to the processor 16 is relayed by the processor 16 and then provided to the transmitter 15. The communication signal provided to the transmitter 15 is modulated and provided to the power line 2 through the bandpass filter 13 and the switch 12a, and is superimposed on the direct-current power of the power line 2 and transmitted in the left direction of FIG. 3.

This embodiment can also achieve similar effects to the embodiment shown in FIG. 2. In addition, this embodiment can downsize the configuration of the relay unit.

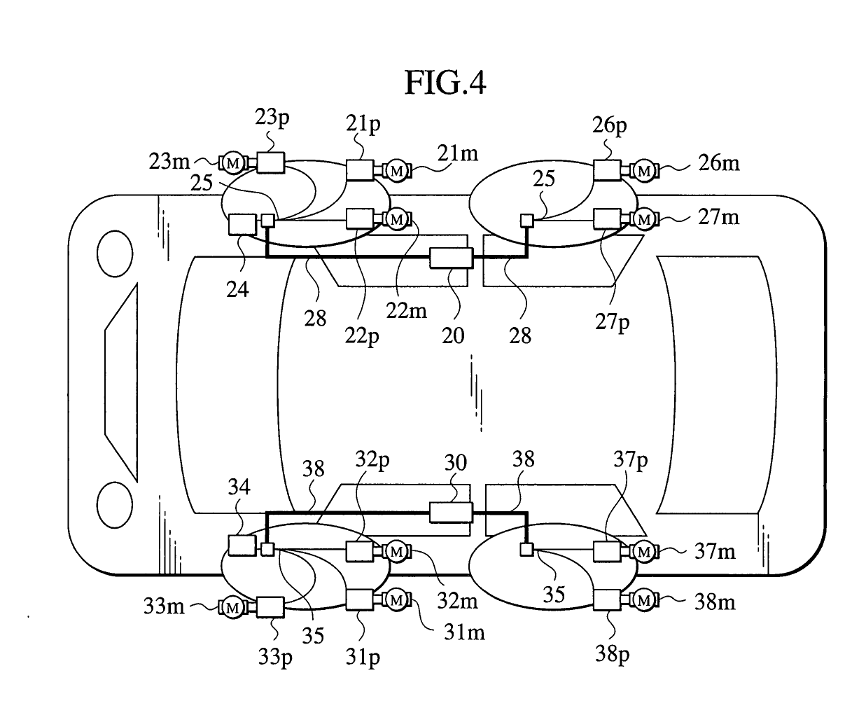

FIG. 4 is a view showing an embodiment of arrangement positions of the relay units shown in FIG. 2 or FIG. 3 in a vehicle. In FIG. 4, in this embodiment, one relay unit 20 is disposed inside a front right side door in a position close to a rear right side door, and another relay unit 30 is disposed inside a front left side door in a position close to a rear left side door.

A slave side PLC 21p disposed in the vicinity of a drive motor 21m for a front right side power window, a slave side PLC 22p disposed in the vicinity of a drive motor 22m for a front right side door lock, and a slave side PLC 23p disposed in the vicinity of a drive motor 23m for a right side mirror of a vehicle are connected to a master side PLC 24 provided inside the front right side door through a power line 25 included in a wire harness. Meanwhile, a slave side PLC 26p disposed in the vicinity of a drive motor 26m for a rear right side power window is connected to a slave side PLC 27p disposed in the vicinity of a drive motor 27m for a rear right door lock through the power line 25 included in the wire harness.

Moreover, the master side PLC 24 is connected to PLCs 26p and 27p on the rear side through a power line 28, which is wired between the front right side door and the rear right side door as a long-distance communication path. The relay unit 20 is disposed on the power line 28 provided as the long-distance communication path.

Similarly, a slave PLC 31p disposed in the vicinity of a drive motor 31m for a front left side power window, a slave side PLC 32p disposed in the vicinity of a drive motor 32m for a front left side door lock, and a slave side PLC 33p disposed in the vicinity of a drive motor 33m for a left side mirror of the vehicle are connected to a master side PLC 34 provided inside the front left side door through a power line 35 included in a wire harness. Meanwhile, a slave PLC 36p disposed in the vicinity of a drive motor 36m for a rear left side power window is connected to a slave side PLC 37p disposed in the vicinity of a drive motor 37m for a rear left door lock through the power line 35 included in the wire harness.

Moreover, the master side PLC 34 is connected to PLCs 36p and 37p on the rear side through a power line 38, which is wired between the front left door and the rear left door as a long-distance communication path. The relay unit 30 is disposed on the power line 38 provided as the long-distance communication path.

By disposing the relay units 20 and 30 as described above, the PLCs disposed in the front door and the PLCs disposed in the rear door can communicate with one another through the power line. Accordingly, in contrast to the related art in which master side PLCs need to be provided on the rear side without disposing of the relay units 20 and 30, it is possible to control the slave PLCs provided on the front and rear doors by use of one master PLC. Therefore, it is not necessary to dispose a master PLC on the rear side.

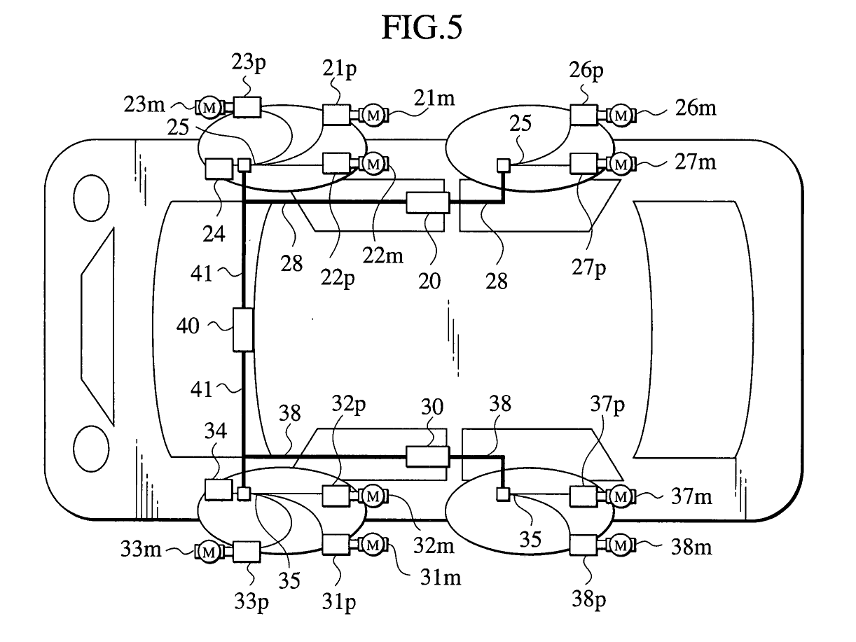

FIG. 5 is a view showing another embodiment of arrangement positions of the relay units shown in FIG. 2 or FIG. 3 in a vehicle. In FIG. 5, this embodiment is characterized in that a third relay unit 40 is disposed on a power line 41 inside or near an ECU of an instrument panel so as to connect and enable communication between the PLCs which are disposed on the right and left doors through the power line 41. Other constitutions of this embodiment are similar to those described in FIG. 4.

This embodiment can also achieve similar effects to the embodiment shown in FIG. 4. In addition, it is possible to control all the PLCs disposed in the front, rear, right, and left doors collectively.

What is claimed is:

1. A relay unit of a power line communication device for a vehicle inserted to a power line connecting between power line communication devices for a vehicle configured to superimpose a communication signal on direct-current power on the power line provided to supply the direct-current power to a vehicle and then transmit, wherein the relay unit is configured to relay the communication signal between the power line communication devices for a vehicle, said relay unit of a power line communication device for a vehicle comprising:
a separator inserted to the power line provided to supply power to the power line communication devices for a vehicle and configured to block and separate the communication signal transmitted on the power line;
a first switch connected to one end of the power line separated by the separator;
a second switch connected to another end of the power line separated by the separator;
a first receiver configured to receive the communication signal provided from the power line through the first switch;
a second receiver configured to receive the communication signal provided from the power line through the second switch;
a first transmitter configured to output and transmit the communication signal received and relayed by the first receiver to the other end of the power line through the second switch;
a second transmitter configured to output and transmit the communication signal received and relayed by the second receiver to the one end of the power line through the first switch; and
a processor configured to receive the communication signal received by the first receiver and relay the communication signal so as to provide the relayed communication signal to the first transmitter, to receive the communication signal received by the second receiver and relay the communication signal so as to provide the relayed communication signal to the second transmitter, and to switch-control the first and second switches.

2. A relay unit of a power line communication device for a vehicle inserted to a power line connecting between power line communication devices for a vehicle configured to superimpose a communication signal on direct-current power on the power line provided to supply the direct-current power to a vehicle and transmit, wherein the relay unit is configured to relay the communication signal between the power line communication devices for a vehicle, said relay unit of a power line communication device for a vehicle comprising:
a separator which inserted to the power line provided to supply power to the power line communication devices for a vehicle and configured to block and separate the communication signal transmitted on the power line;
a first switch connected to one end of the power line separated by the separator;
a second switch connected between another end of the power line separated by the separator and the first switch;
a receiver configured to receive the communication signal provided from the power line through any of the first switch and the second switch;
a transmitter configured to output and transmit the communication signal received and relayed by the receiver to any of the one end and the other end of the power line through any of the first switch and the second switch; and
a processor configured to receive the communication signal received by the receiver and relay the communication signal so as to provide the relayed communication signal to the transmitter, to judge a direction of transmission of the received communication signal based on a signal pattern of the communication signal, and to switch-control the first and second switches in accordance with a result of judgment.

3. The relay unit of a power line communication device for a vehicle according to claim 1,
wherein the relay unit is inserted to the power line connecting between the power line communication devices for a vehicle which are disposed in front and rear doors of the vehicle, and relays a communication signal transmitted between the power line communication devices for a vehicle through the power line.

4. The relay unit of a power line communication device for a vehicle according to claim 2,
wherein the relay unit is inserted to the power line connecting between the power line communication devices for a vehicle which are disposed in front and rear doors of the vehicle, and relays a communication signal transmitted between the power line communication devices for a vehicle through the power line.

5. The relay unit of a power line communication device for a vehicle according to claim 3,
wherein the relay unit is inserted to the power line connecting between the power line communication devices for a vehicle which are disposed in right and left doors of the vehicle, and relays a communication signal transmitted between the power line communication devices for a vehicle through the power line.

6. The relay unit of a power line communication device for a vehicle according to claim 4,
wherein the relay unit is inserted to the power line connecting between the power line communication devices for a vehicle which are disposed in right and left doors of the vehicle, and relays a communication signal transmitted between the power line communication devices for a vehicle through the power line.
